(19) United States
(12) Patent Application Publication
(10) Pub. No.: US 2023/0408700 A1
(43) Pub. Date: Dec. 21, 2023

(54) OPTICAL DISTANCE-MEASURING DEVICE AND IMAGE FORMING APPARATUS

(71) Applicant: FUJIFILM Business Innovation Corp., Tokyo (JP)

(72) Inventors: Kazuhiro SAKAI, Kanagawa (JP); Hiroyuki HOTTA, Kanagawa (JP); Kei TAKEYAMA, Kanagawa (JP); Shigetoshi NAKAMURA, Kanagawa (JP); Yoshihiro YAMAMOTO, Kanagawa (JP); Junichiro HAYAKAWA, Kanagawa (JP)

(73) Assignee: FUJIFILM Business Innovation Corp., Tokyo (JP)

(21) Appl. No.: 17/982,012

(22) Filed: Nov. 7, 2022

(30) Foreign Application Priority Data
Jun. 15, 2022 (JP) 2022-096860

(51) Int. Cl. G01S 17/894; G01S 7/4865

(52) U.S. Cl. CPC G01S 17/894; G01S 7/4865

(57) ABSTRACT

An optical distance-measuring device includes: a light emitter having plural light-emitting areas that are arrayed in a first direction; an optical system provided at a position toward which the light emitter emits light, the optical system causing light beams respectively emitted from the plural light-emitting areas to be deflected in respectively different directions; and a detector including plural detecting elements configured to detect a reflection of light outgoing from the optical system. Detecting directions of some of the plural detecting elements are different from detecting directions of others of the plural detecting elements in the first direction.

### CROSS-REFERENCE TO RELATED APPLICATIONS

This application is based on and claims priority under 35 USC 119 from Japanese Patent Application No. 2022-096860 filed Jun. 15, 2022.

### BACKGROUND

### (i) Technical Field

The present disclosure relates to an optical distance-measuring device and an image forming apparatus.

### (ii) Related Art

According to Japanese Patent No. 4427954, a monitoring device configured to perform two-dimensional scanning of an object to be monitored includes a lighting lens located face to face with a vertical-cavity surface-emitting-laser (VCSEL) array in which a plurality of laser diodes are arranged two-dimensionally.

According to Japanese Patent No. 5257053, an optical scanning device configured to scan a scanning-object surface with laser light includes a laser-array light source, a condensing lens that condenses laser light, and a movable mirror that reflects the condensed laser light toward the scanning-object surface.

According to Japanese Patent No. 6965784, a distance-measuring device configured to perform scanning with a light beam includes a light source and an optical scanning unit that includes a micromirror.

### SUMMARY

Such a commercialized optical distance-measuring device includes a light emitter having a plurality of light-emitting areas that are arrayed in a first direction, an optical system configured to cause light beams respectively emitted from the plurality of light-emitting areas to be deflected in respectively different directions, and a detector including a plurality of detecting elements configured to detect the reflection of light outgoing from the optical system. The optical distance-measuring device is configured to measure the distance to an object that is present within a scanning range thereof by performing scanning in the first direction with the light beams of the light emitter and detecting the reflection of the light beams.

However, since the detectivity of the detecting elements is angle-dependent, the detectivity varies within the scanning range.

Aspects of non-limiting embodiments of the present disclosure relate to an optical distance-measuring device and an image forming apparatus in each of which the variation in detectivity within a scanning range is smaller than in a case where the detecting directions of detecting elements included in a detector are uniform in a first direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an optical distance-measuring device including: a light emitter having a plurality of light-emitting areas that are arrayed in a first direction; an optical system provided at a position toward which the light emitter emits light, the optical system causing light beams respectively emitted from the plurality of light-emitting areas to be deflected in respectively different directions; and a detector including a plurality of detecting elements configured to detect a reflection of light outgoing from the optical system, wherein detecting directions of some of the plurality of detecting elements are different from detecting directions of others of the plurality of detecting elements in the first direction.

### BRIEF DESCRIPTION OF THE DRAWINGS

Exemplary embodiments of the present disclosure will be described in detail based on the following figures, wherein:

FIG. 1 is a schematic external view of an image forming apparatus according to a first exemplary embodiment;

FIG. 2 illustrates how an optical distance-measuring device detects a user approaching the image forming apparatus to use the apparatus;

FIG. 3 is a schematic front view of the optical distance-measuring device;

FIG. 4 is a schematic bottom view of the optical distance-measuring device;

FIG. 5 schematically illustrates a VCSEL array;

FIG. 6 illustrates optical paths of light beams emitted from the VCSEL array in an XZ plane;

FIG. 7 illustrates a circuit including photodetectors (PDs) and an analog front end (AFE) connected thereto;

FIG. 8 outlines the PD;

FIG. 9 schematically illustrates the inside of the PD;

FIG. 10A illustrates the angular characteristic of detectivity that is angle-dependent;

FIG. 10B illustrates the angular characteristic of detectivity that is not angle-dependent;

FIG. 11 is a graph illustrating the quantity of detected light versus the absolute value of the inclination of each of two PDs in the X-axis direction, with the angle of the light outgoing from the optical distance-measuring device varied;

FIG. 12 is a graph illustrating the quantity of detected light versus the absolute value of the inclination of each of the two PDs in the X-axis direction, with the angle of the light outgoing from the optical distance-measuring device varied;

FIG. 13 is a graph illustrating the variation in detectivity at an angle of radiation of 150° versus the absolute value of the inclination of the two PDs in the X-axis direction;

FIG. 14 schematically illustrates a VCSEL array according to a modification;

FIG. 15 illustrates optical paths of light beams emitted from the VCSEL array according to the modification in an XZ plane;

FIG. 16 illustrates optical paths of light beams emitted from the VCSEL array according to the modification in a YZ plane;

FIG. 17 is a schematic bottom view of an optical distance-measuring device according to another modification;

FIG. 18 is a schematic front view of an optical distance-measuring device according to a first example;

FIG. 19 is a schematic front view of an optical distance-measuring device according to a second example;

FIG. 20 is a schematic front view of an optical distance-measuring device according to a third example;

FIG. 21 is a schematic front view of an optical distance-measuring device according to a fourth example;

FIG. 22 is a schematic front view of an optical distance-measuring device according to a fifth example;

FIG. 23 is a schematic front view of an optical distance-measuring device according to a sixth example;

FIG. 24 is a schematic front view of an optical distance-measuring device according to a seventh example;

FIG. 25 is a schematic front view of an optical distance-measuring device according to an eighth example;

FIG. 26 is a schematic front view of an optical distance-measuring device according to a ninth example; and

FIG. 27 is a schematic external view of a human-sensing gate according to a second exemplary embodiment.

### DETAILED DESCRIPTION

### First Exemplary Embodiment

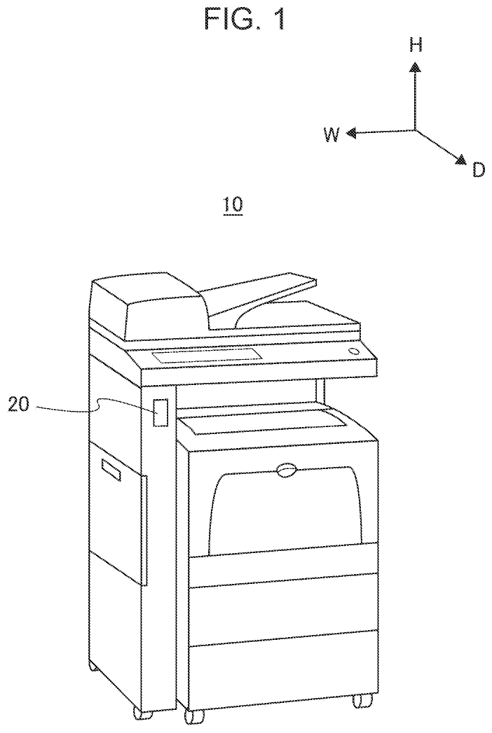

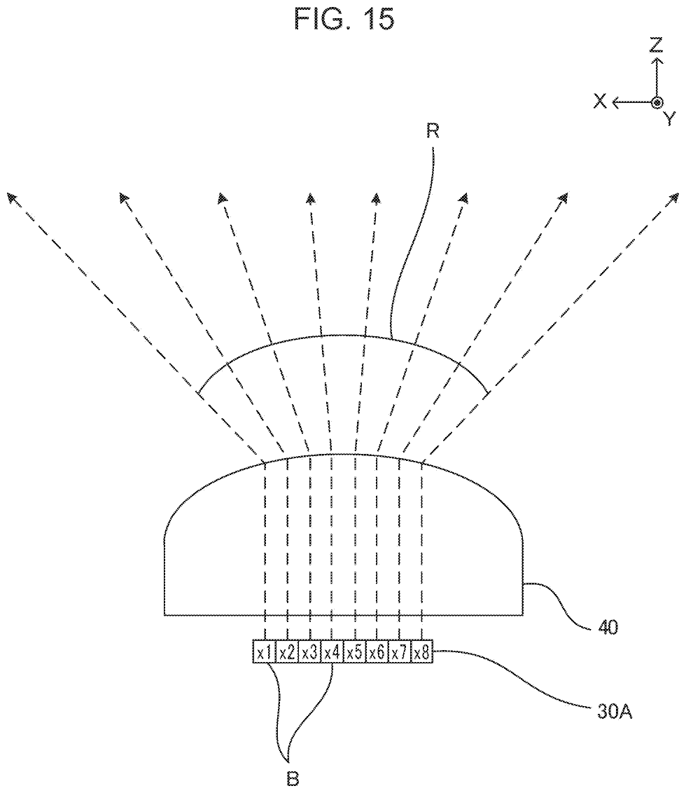

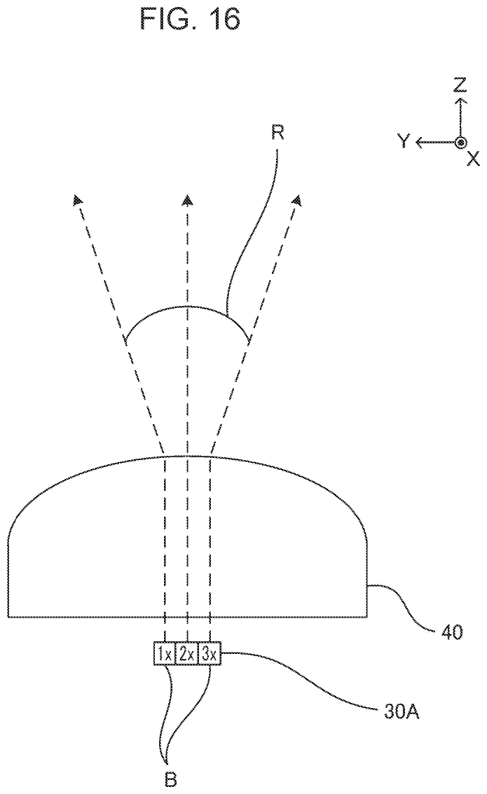

Overall Configuration of Image Forming Apparatus A first exemplary embodiment of the present disclosure will now be described with reference to FIGS. 1 to 17. FIG. 1 is a schematic external view of an image forming apparatus 10 according to the first exemplary embodiment of the present disclosure. The W axis, the H axis, and the D axis provided in FIG. 1 represent the coordinate axes of the image forming apparatus 10. The W axis extends in a horizontal direction and represents the width direction of the apparatus 10, the H axis extends in the vertical direction and represents the top-to-bottom direction of the apparatus 10, and the D axis extends in another horizontal direction and represents the depth direction of the apparatus 10.

As illustrated in FIG. 1, the image forming apparatus 10 is an apparatus called a multifunction machine having a plurality of functions including a printing function, a scanning function, a copying function, and a facsimile function. The image forming apparatus 10 has on the front face thereof an optical distance-measuring device which serves as a human sensor configured to detect any user who intends to use the apparatus 10.

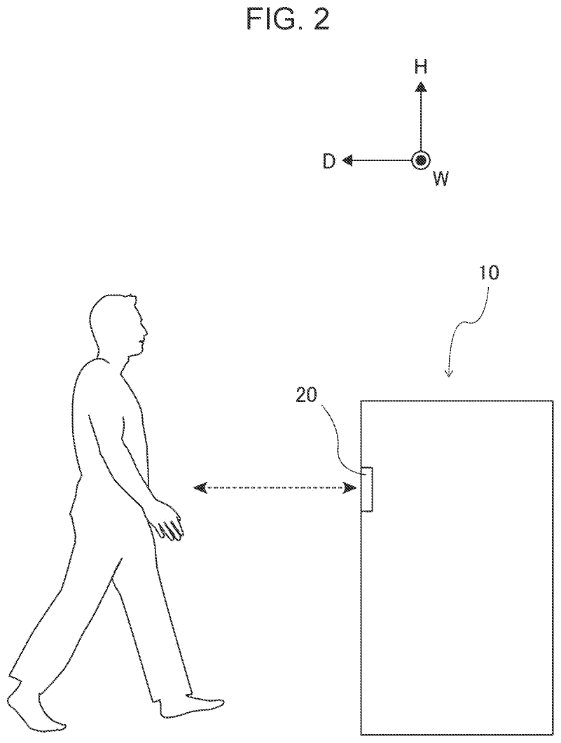

FIG. 2 illustrates how the optical distance-measuring device 20 detects a user approaching the image forming apparatus 10 to use the apparatus 10. As illustrated in FIG. 2, the optical distance-measuring device is set in such a manner as to detect a typical user, who is coming toward a location where the image forming apparatus 10 is installed.

In the first exemplary embodiment, for example, when any user who intends to use the image forming apparatus 10 is detected by the optical distance-measuring device 20 while the image forming apparatus 10 is in an energy-saving mode, the image forming apparatus 10 is controlled to resume a normal operation mode.

### Configuration of Optical Distance-Measuring Device

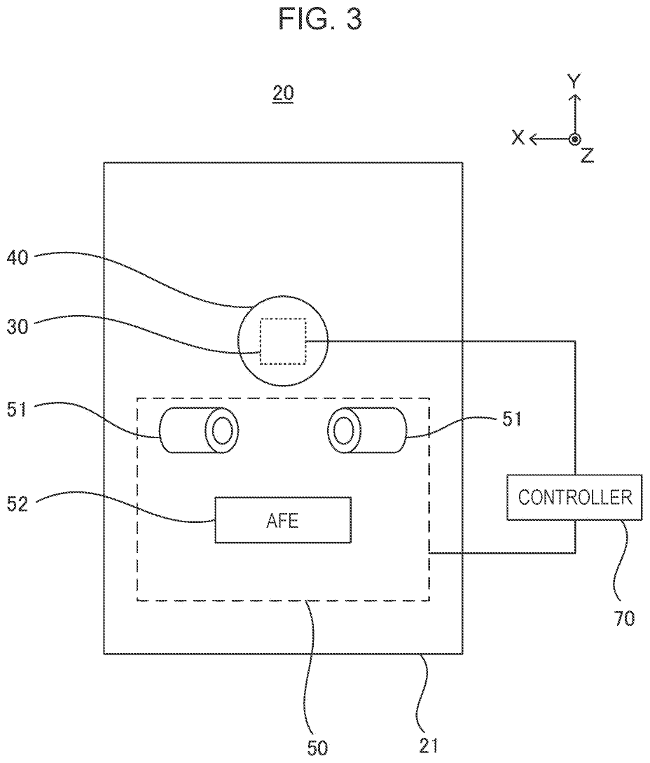

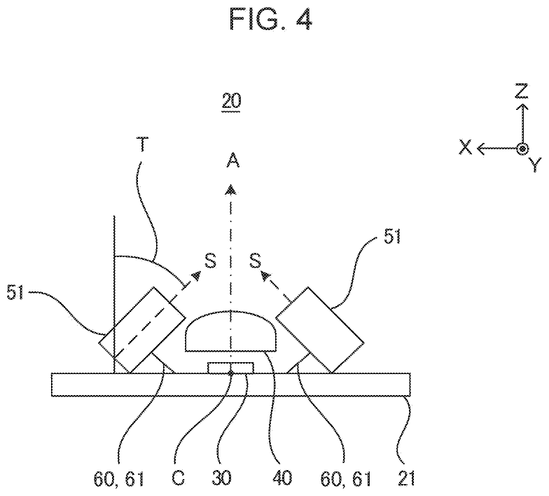

FIG. 3 is a schematic front view of the optical distance-measuring device 20 according to the first exemplary embodiment. FIG. 4 is a schematic bottom view of the optical distance-measuring device 20 according to the first exemplary embodiment. The X axis, the Y axis, and the Z axis provided in FIGS. 3 and 4 define the coordinate system of the optical distance-measuring device 20. The X-axis direction corresponds to the first direction in the technique according to the present disclosure. The Y-axis direction is an example of the second direction that intersects the first direction in the technique according to the present disclosure.

As illustrated in FIGS. 3 and 4, the optical distance-measuring device 20 includes a VCSEL array 30, which includes a plurality of light-emitting areas B; an optical system 40, which causes light beams respectively emitted from the plurality of light-emitting areas B to be deflected in respectively different directions; a detecting unit 50, which is configured to detect the reflection of light outgoing from the optical system 40; and a controller 70. The VCSEL array 30, the optical system 40, and the detecting unit 50 are provided on a substrate 21.

The VCSEL array 30 is an example of the light emitter in the technique according to the present disclosure. In the following description, the term “center position C of the VCSEL array 30” refers to the center, C, of the plurality of light-emitting areas B as a whole in the VCSEL array 30.

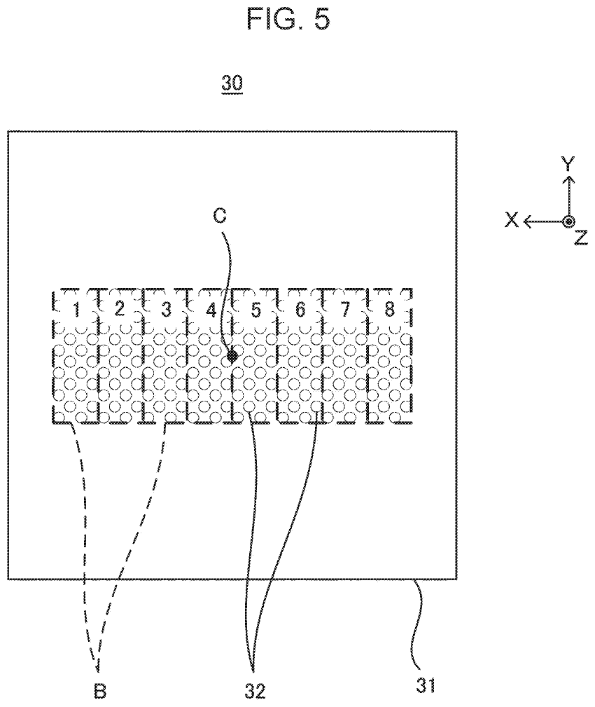

FIG. 5 schematically illustrates the VCSEL array 30. As illustrated in FIG. 5, the VCSEL array 30 includes a plurality of light-emitting devices 32, which are based on a vertical-cavity surface-emitting-laser (VCSEL) scheme and are arranged in a staggered pattern on a part of the substrate 31.

The plurality of light-emitting areas B of the VCSEL array 30 are defined side by side in the X-axis direction. Each of the light-emitting areas B of the VCSEL array 30 is provided with a plurality of light-emitting devices 32. The light-emitting devices 32 of the VCSEL array 30 are controlled to be turned on and off in units of the light-emitting areas B. FIG. 5 illustrates an exemplary arrangement in which eight light-emitting areas B numbered from 1 to 8 are defined side by side in the X-axis direction.

The optical system 40 is located at a position toward which the VCSEL array 30 emits light, and is configured to cause the light beams respectively emitted from the plurality of light-emitting areas B to be deflected in respectively different directions. The optical system 40 has an optical axis A, which extends through the center position C of the VCSEL array 30 and is orthogonal to a surface of the substrate 31 on which the light-emitting devices 32 are provided. The optical system 40 is, for example, a lens. Such a lens serving as the optical system 40 may be any number of lenses having any shapes, as long as the light beams respectively emitted from the plurality of light-emitting areas B are deflectable in respectively different directions.

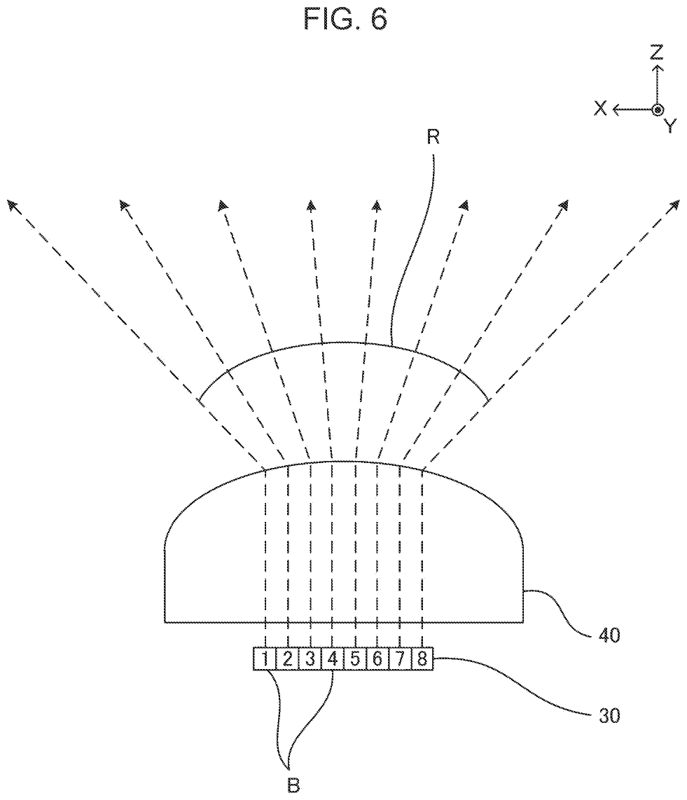

FIG. 6 illustrates optical paths of the light beams emitted from the VCSEL array 30 in an XZ plane. In the first exemplary embodiment, as illustrated in FIG. 6, the VCSEL array 30 has eight light-emitting areas B defined side by side in the X-axis direction.

The optical system 40 causes the light beams emitted from the respective light-emitting areas B numbered from 1 to 8 to be deflected in respectively different directions. Herein, the angle formed between two light beams emitted from the respective outermost ones of the light-emitting areas B and outgoing from the optical system 40 is referred to as the angle of radiation from the optical distance-measuring device 20.

In the first exemplary embodiment, the angle of radiation from the optical distance-measuring device 20 is denoted by R and is formed between the light beam emitted from one outermost light-emitting area B numbered 1 and outgoing from the optical system 40 and the light beam emitted from the other outermost light-emitting area B numbered 8 and outgoing from the optical system 40. In the first exemplary embodiment, the angle of radiation from the optical distance-measuring device 20 is, for example, 100°.

The detecting unit 50 includes a plurality of photodetectors (PDs) 51, which are configured to detect the reflection of light outgoing from the optical system 40; and an analog front end (AFE) 52, which is configured to adjust analog signals outputted from the respective PDs 51 into signals that are easily handleable by a subsequent circuit. The PDs 51 are each an example of the detecting element in the technique according to the present disclosure.

As illustrated in FIGS. 3 and 4, detecting directions S of some of the plurality of PDs 51 are different from detecting directions S of the other PDs 51 in the X-axis direction.

The PDs 51 of the detecting unit 50 may include PDs 51 located on the opposite sides relative to the center position C of the VCSEL array 30 in the X-axis direction.

The detecting directions S of the PDs 51 located on the opposite sides relative to the center position C of the VCSEL array 30 in the X-axis direction may be inclined toward the VCSEL array 30 in the X-axis direction. In such an arrangement, the PDs 51 located on the opposite sides relative to the center position C of the VCSEL array 30 in the X-axis direction may be located at different positions in the Y-axis direction.

The detecting directions S of the PDs 51 located on the opposite sides relative to the center position C of the VCSEL array 30 in the X-axis direction may be inclined away from the VCSEL array 30 in the X-axis direction.

The direction of drawing a wire from each of the PDs 51 located on the opposite sides relative to the center position C of the VCSEL array 30 in the X-axis direction may be inclined toward the VCSEL array 30 in the X-axis direction.

Alternatively, the PDs 51 of the detecting unit 50 may include PDs 51 located on the opposite sides relative to the center position C of the VCSEL array 30 in the Y-axis direction.

The detecting directions S of the PDs 51 located on the opposite sides relative to the center position C of the VCSEL array 30 in the Y-axis direction may be inclined toward the VCSEL array 30 in the Y-axis direction. In such an arrangement, the PDs 51 located on the opposite sides relative to the center position C of the VCSEL array 30 in the Y-axis direction may be located at different positions in the X-axis direction.

The detecting directions S of the PDs 51 located on the opposite sides relative to the center position C of the VCSEL array 30 in the Y-axis direction may be inclined away from the VCSEL array 30 in the Y-axis direction.

The direction of drawing a wire from each of the PDs 51 located on the opposite sides relative to the center position C of the VCSEL array 30 in the Y-axis direction may be inclined toward the VCSEL array 30 in the Y-axis direction.

If the angle of radiation in the X-axis direction that is formed by the light emitted from the VCSEL array 30 and outgoing from the optical system 40 is 80° or greater, the PDs 51 of the detecting unit 50 may include two PDs 51 that are inclined toward opposite sides in the X-axis direction and whose angles of inclination (inclination T, illustrated in FIG. 4) with respect to the optical axis A of the optical system 40 are each 42.5° or greater and 62.5° or smaller in absolute value.

In the first exemplary embodiment, the detecting unit 50 includes, for example, two PDs 51 located on the opposite sides relative to the center position C of the VCSEL array 30 in the X-axis direction. Furthermore, the AFE 52 is located at the midpoint between the two PDs 51 in the X-axis direction.

The detecting directions S of the two PDs 51 located on the opposite sides relative to the center position C of the VCSEL array 30 in the X-axis direction are inclined toward the VCSEL array 30 in the X-axis direction. The absolute values of the inclinations of the two PDs 51 are, for example, 45°.

The PDs 51 each have, for example, a circular cylindrical shape and are each provided with two wires: a wire 60 and a wire 61, which are drawn from the peripheral face of the PD 51 and through which a detection signal is to be outputted.

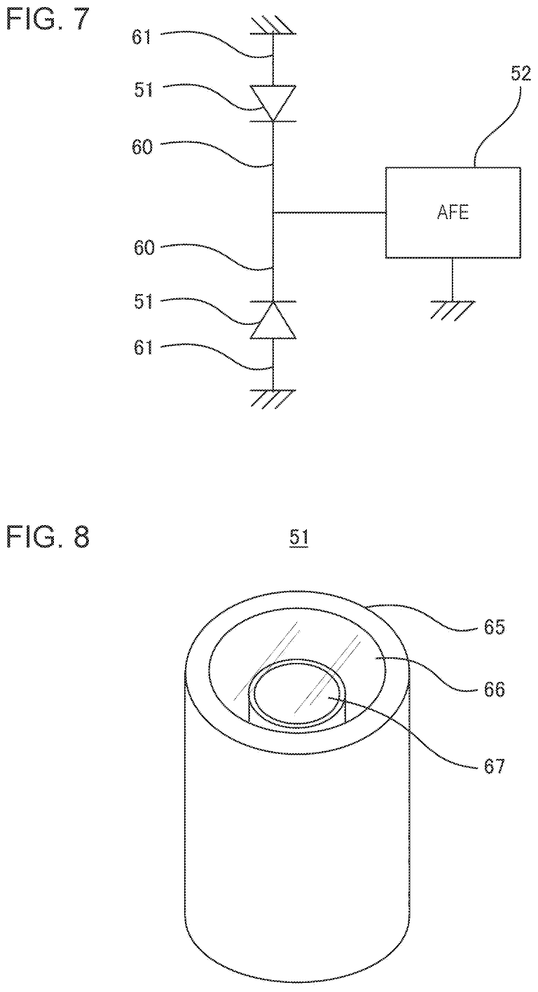

FIG. 7 illustrates a circuit including the PDs 51 and the AFE 52 connected thereto. As illustrated in FIG. 7, the two PDs 51 are connected in parallel with each other and to the AFE 52. The wire 60, which is one of the two wires drawn from each of the PDs 51, is connected to the AFE 52. The wire 61, which is the other of the two wires drawn from each of the PDs 51, is connected to the ground.

As illustrated in FIGS. 3 and 4, the direction of drawing the wires 60 and 61 from each of the two PDs 51 located on the opposite sides relative to the center position C of the VCSEL array 30 in the X-axis direction is inclined toward the VCSEL array 30 in the X-axis direction.

The controller 70 includes a central processing unit (CPU), a memory, a storage, and so forth. The controller 70 is configured to control the operations of the VCSEL array 30 and the detecting unit 50 and to calculate the distance from the optical distance-measuring device 20 to an object of measurement with reference to signals received from the PDs 51.

Specifically, the controller 70 first causes a first light-emitting area B, which is located at one end of the array of the plurality of light-emitting areas B in the X-axis direction, to emit light. Subsequently, the controller 70 causes the PDs 51 to detect the reflection of the light emitted from the first light-emitting area B. Then, with reference to signals obtained through the detection by the PDs 51, the controller 70 calculates the gap between the time when light is emitted from the first light-emitting area B and the time when the reflection is detected by the PDs 51. With reference to the time gap thus calculated, the controller 70 calculates the distance from the optical distance-measuring device 20 to the object of measurement within a detectable range for the first light-emitting area B. Subsequently, the controller 70 causes a second light-emitting area B, which is adjacent to the first light-emitting area B, to emit light and calculates the distance to the object of measurement as in the same manner as for the first light-emitting area B. The above process is repeated for all of the plurality of light-emitting areas B arrayed in the X-axis direction, whereby scanning in the X-axis direction is performed in which the distance from the optical distance-measuring device 20 to the object of measurement is calculated for each of all the detectable ranges.

The optical distance-measuring device 20 is set in the image forming apparatus 10 such that the X-axis direction thereof coincides with the horizontal direction of the image forming apparatus 10 while the Y-axis direction thereof coincides with the vertical direction of the image forming apparatus 10.

### Functions of Optical Distance-Measuring Device and Image Forming Apparatus

The light detectivity of each PDs 51 is angle-dependent: if the angle of incidence on the PD 51 is 0°, that is, if light traveling parallel to the detecting direction S is incident on the PD 51, the PD 51 exerts highest detectivity. The greater the angle of incidence with respect to the detecting direction S, the lower the detectivity. Moreover, in an area where the angle of incidence with respect to the detecting direction S is greater than a specific angle, the detection of light is physically impossible because of a Fresnel loss occurring in the PD 51 and mechanical factors of the PD 51.

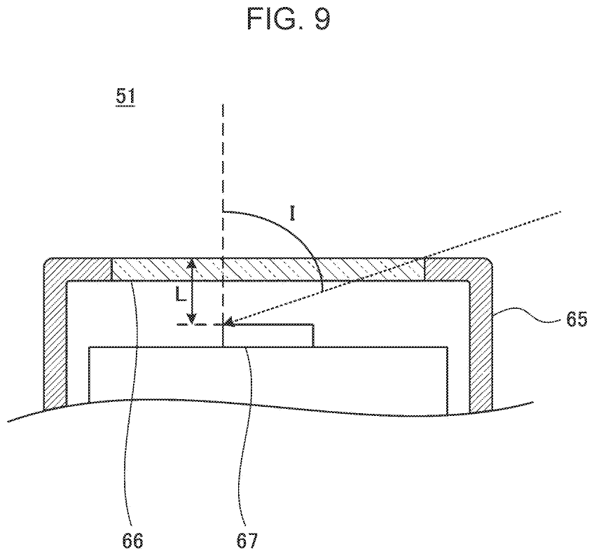

FIG. 8 outlines the PD 51. FIG. 9 schematically illustrates the inside of the PD 51. In FIGS. 8 and 9, the wire 60 and the wire 61 are not illustrated.

FIGS. 8 and 9 illustrate an exemplary configuration of the PD 51, in which a housing 65 has in one face thereof an entrance window 66 and houses a light receptor 67, which is configured to detect light. In the first exemplary embodiment, the entrance window 66 has a diameter of 3 mm, and the area of light reception by the light receptor 67 has a diameter of 1.2 mm. A surface of the entrance window 66 on which light is incident and a surface of the light receptor 67 at which light is received are at an interval L of 0.8 mm from each other.

In such a configuration, light at an angle of incidence I of 69.1° or greater is blocked by the housing 65 and is therefore physically undetectable. Actually, even in an area where the angle of incidence I is smaller than 69.1°, the detectivity is lower than the detectivity for an angle of incidence I of 0°, because of Fresnel losses and other factors occurring at the entrance window 66 and in the PD 51.

Thus, the light detectivity of the PD 51 is highest at an angle of incidence of 0° and decreases with the increase in the angle of incidence, reaching the lowest level at an angle of incidence that is greatest within the detectable range for the PD 51.

The angular characteristic of the detectivity of the optical distance-measuring device 20 as a whole is the angular characteristic of the total detectivity exerted by all of the plurality of PDs 51 included in the optical distance-measuring device 20.

Let us consider a case of an optical distance-measuring device 20 that includes two PDs 51 arranged such that the detecting directions S thereof are both parallel to the optical axis A of the optical system 40. In such an optical distance-measuring device 20, the two PDs 51 exert highest detectivity in the same direction. Therefore, in terms of angular characteristic, the light detectivity of the optical distance-measuring device 20 is highest for light perpendicularly incident on the front face of the optical distance-measuring device 20 and decreases with the increase in the angle of incidence with respect to the detecting direction S of the PDs 51.

In contrast, the optical distance-measuring device according to the first exemplary embodiment includes two PDs 51 arranged such that the detecting directions S thereof are different from each other. In the first exemplary embodiment, the two PDs 51 exert highest detectivity in different directions.

Therefore, the light detectivity of the optical distance-measuring device 20 is evened out by the two PDs 51.

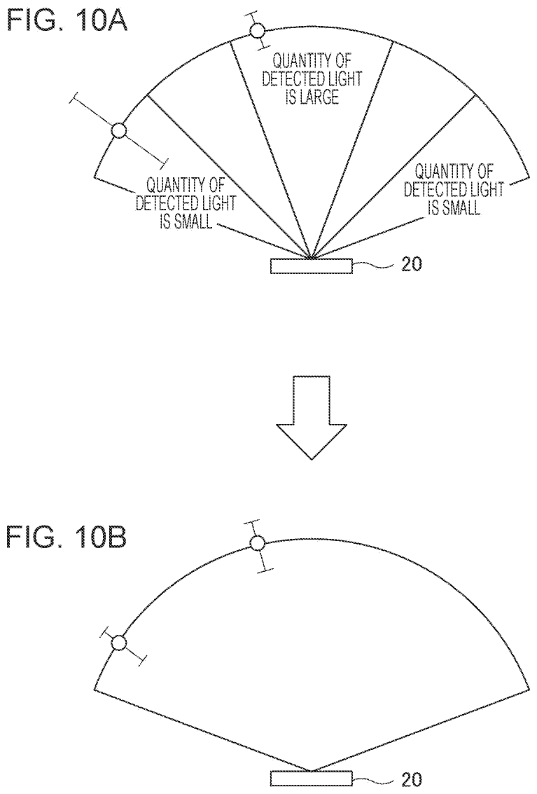

Such an aspect will now be described in more detail with reference to FIGS. 10A and 10B. FIG. 10A illustrates the angular characteristic of detectivity that is angle-dependent, and FIG. 10B illustrates the angular characteristic of detectivity that is not angle-dependent.

As illustrated in FIG. 10A, if the detectivity is angle-dependent, the level of detectivity varies with the angle. Therefore, even if the distance from the optical distance-measuring device 20 to the object of measurement is uniform, the quantity of detected light varies with the angle, making the result of the measurement unstable.

In contrast, if the detectivity is not angle-dependent as illustrated in FIG. 10B, the level of detectivity is uniform at any angle. Therefore, if the distance from the optical distance-measuring device 20 to the object of measurement is uniform, the quantity of detected light is uniform at any angle, making the result of the measurement stable. That is, the less angle dependence in detectivity, the better.

Referring to FIG. 7, in a circuit including two PDs 51 and an AFE 52, the wire length from each of the two PDs 51 to the AFE 52 and the wire length from each of the two PDs 52 to the ground may be equal to each other, in view of causing the two PDs 51 to detect the same measuring light with the same timing. Herein, the wire length from the PD 51 to the AFE 52 refers to the sum of the length of the wire drawn from the PD 51 and the length of a wire laid on the circuit board and connecting the wire 60 to the AFE 52. Furthermore, the wire length from the PD 51 to the ground refers to the sum of the length of the wire 61 drawn from the PD 51 and the length of a wire laid on the circuit board and connecting the wire 61 to the ground for the AFE 52.

In the circuit including two PDs 51 and an AFE 52, the wire length from each of the two PDs 51 to the AFE 52 and the wire length from each of the two PDs 51 to the ground for the AFE 52 may be as short as possible, in view of reducing the parasitic capacity and the parasitic inductance that tend to affect the measurement.

In the optical distance-measuring device 20 according to the first exemplary embodiment, the direction of drawing the wires 60 and 61 from each of the two PDs 51 located on the opposite sides relative to the center position C of the VCSEL array 30 in the X-axis direction is inclined toward the VCSEL array 30 in the X-axis direction.

In such an arrangement, since the AFE 52 is located at the midpoint between the two PDs 51, the wire length from each of the two PDs 51 to the AFE 52 and the wire length from each of the two PDs 51 to the ground are equal and short, compared with a case where the direction of drawing the wires 60 and 61 from each of the two PDs 51 is inclined away from the VCSEL array 30.

Now, changes in relevant characteristics of the optical distance-measuring device 20 that occur by varying the inclinations of the PDs will be described by taking an exemplary case where the optical distance-measuring device 20 includes two PDs 51 that are inclined toward opposite sides in the X-axis direction and whose inclinations with respect to the optical axis A of the optical system 40 are equal in absolute value.

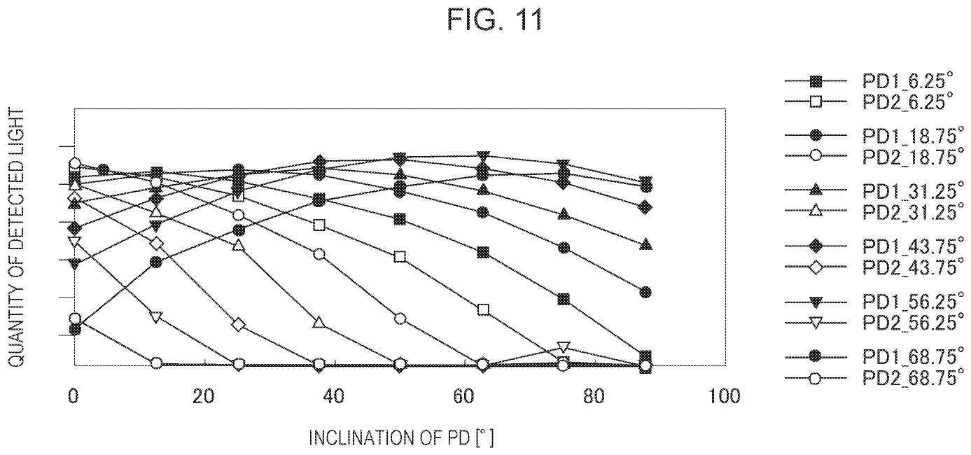

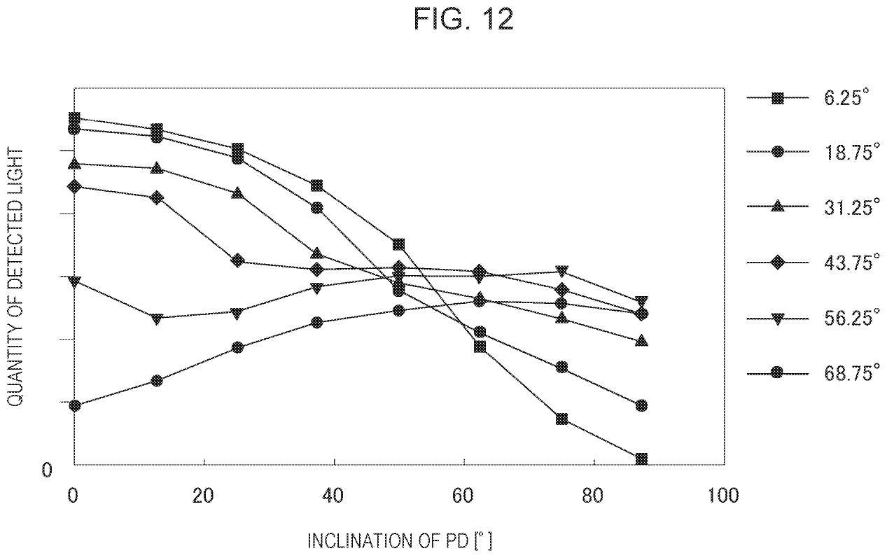

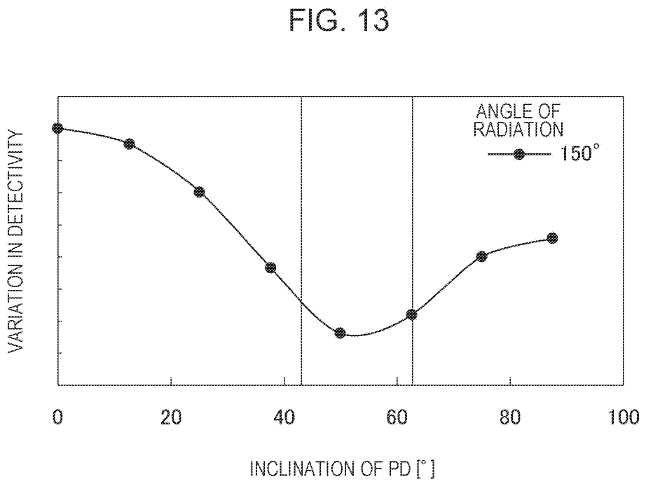

FIG. 11 is a graph illustrating the quantity of detected light versus the absolute value of the inclination of each of the two PDs 51, denoted as PD 1 and PD 2, in the X-axis direction, with the angle of the light outgoing from the optical distance-measuring device 20 varied. In the graph illustrated in FIG. 11, the horizontal axis represents the absolute value of the inclination of each of PD 1 and PD 2 in the X-axis direction, and the vertical axis represents the quantity of detected light.

Herein, “the angle of the light outgoing from the optical distance-measuring device 20” refers to the angle formed by the light beam emitted from each of the outermost light-emitting areas B of the VCSEL array 30 and outgoing from the optical system 40 with respect to the optical axis A of the optical system 40, and is also simply referred to as “the angle of the outgoing light”.

The graph illustrated in FIG. 11 provides data for six cases, with the angle of the outgoing light varied among 6.25°, 18.75°, 31.25°, 43.75°, 56.25°, and 68.75°. The data for the foregoing angles of the outgoing light are plotted for each of PD 1 and PD 2. PD 1 is one of the two PDs 51 that are arrayed in the X-axis direction. PD 2 is the other of the two PDs 51 that are arrayed in the X-axis direction and is inclined in the X-axis direction by the same angle (in absolute value) as for PD 1 but toward the opposite side compared with PD 1.

As illustrated in FIG. 11, examining the data for each of the angles of the light outgoing from the optical distance-measuring device 20, the quantity of detected light is smaller in PD 2 than in PD 1 for all angles of the outgoing light, including a case where no light is detected in PD 2. Such a result implies that the detectivity is lower in an arrangement in which the plurality of PDs 51 in the optical distance-measuring device 20 are all inclined in the same manner as for PD 2 than in an arrangement in which the plurality of PDs 51 are all inclined in the same manner as for PD 1. That is, in the optical distance-measuring device 20 including a plurality of PDs 51, it is effective to incline the plurality of PDs 51 in different manners.

FIG. 12 is a graph illustrating the quantity of detected light calculated as the total output of PD 1 and PD 2 versus the absolute value of the inclination of each of PD 1 and PD 2 in the X-axis direction. In the graph illustrated in FIG. 12, the horizontal axis represents the absolute value of the inclination of PD 1 and PD 2 in the X-axis direction, and the vertical axis represents the quantity of detected light calculated as the total output of PD 1 and PD 2.

As is seen from FIG. 12, the variation in detectivity among data for the above different angles of the outgoing light is small when the absolute value of the inclination of PD 1 and PD 2 in the X-axis direction is about 50°.

FIG. 13 is a graph illustrating the variation in detectivity at an angle of radiation of 150° versus the absolute value of the inclination of PD 1 and PD 2 in the X-axis direction. In the graph illustrated in FIG. 13, the horizontal axis represents the absolute value of the inclination of PD 1 and PD 2 in the X-axis direction, and the vertical axis represents the variation in detectivity at an angle of radiation of 150°.

As is seen from FIG. 13, the variation in detectivity is small in a range where the absolute value of the inclination of PD 1 and PD 2 in the X-axis direction is 42.5° or greater and 62.5° or smaller.

In the optical distance-measuring device 20 according to the first exemplary embodiment, the detecting unit 50 includes two PDs 51 that are inclined toward opposite sides but by the same angle of 45° in the X-axis direction in absolute value, which falls within the range of 42.5° or greater and 62.5° or smaller.

In the first exemplary embodiment, the optical distance-measuring device 20 is set in the image forming apparatus such that the X-axis direction thereof coincides with the horizontal direction of the image forming apparatus 10 while the Y-axis direction thereof coincides with the vertical direction of the image forming apparatus 10.

### Modifications of First Exemplary Embodiment

The configuration of the optical distance-measuring device 20 according to the first exemplary embodiment is not limited to the one described above.

For example, the detecting element is not limited to the PD 51 and may be any other element such as a photomultiplier, as long as the element is capable of detecting light.

The arrangement of the light-emitting devices 32 on the substrate 31 of the VCSEL array 30 is not limited to the above-described staggered pattern and may be any other pattern such as a matrix.

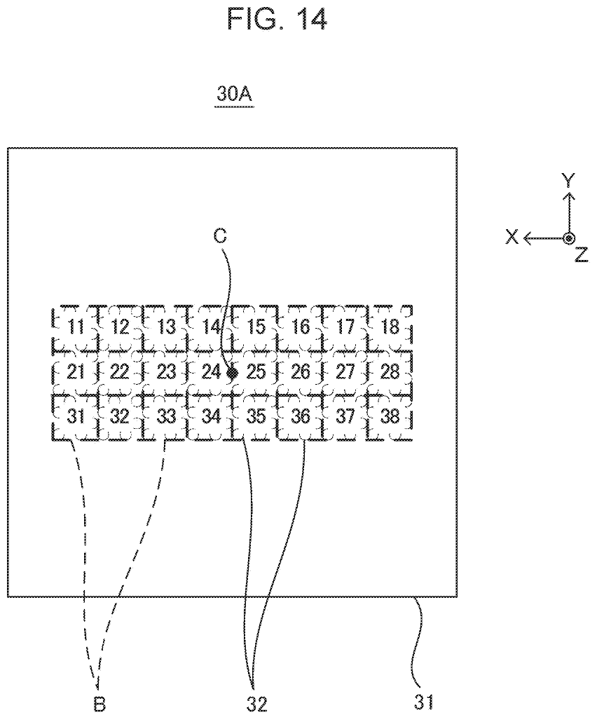

The arrangement of the plurality of light-emitting areas B in the VCSEL array 30 is not limited to the above one-dimensional pattern extending in the X-axis direction and may be a two-dimensional pattern spreading in the X-axis direction and in the Y-axis direction as in a VCSEL array 30A, which is illustrated in FIGS. 14 to 16. In the present modification, a total of twenty-four light-emitting areas B are provided, with eight lines in the X-axis direction and three rows in the Y-axis direction. Such a modification enables two-dimensional optical scanning in the X-axis direction and in the Y-axis direction.

The light emitter is not limited to the VCSEL array 30 and may be any other device such as a light-emitting-diode (LED) array, as long as the device is configured to emit light.

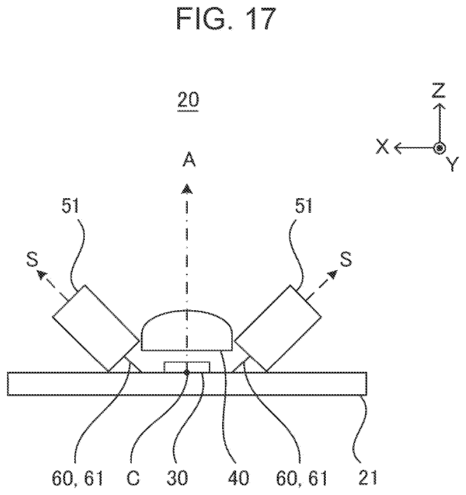

The location where the wire 60 and the wire 61 are drawn from each of the two PDs 51 of the detecting unit 50 is not limited to the peripheral face of the PD 51 and may be the bottom face of the PD 51. As illustrated in FIG. 17, in an arrangement in which the detecting directions S of the two PDs 51 are each inclined away from the VCSEL array 30 in the X-axis direction, the wire 60 and the wire 61 may be drawn from the bottom face of each of the PDs 51.

The configuration of the detecting unit 50 is not limited to the one described above and may be changed in any way, including the following examples 1 to 9.

### Examples of Detecting Unit

Examples of the detecting unit 50 included in the optical distance-measuring device 20 according to the present disclosure will now be described. The following examples are obtained by changing the number of PDs 51 included in the detecting unit 50 and/or the arrangement of the PDs 51.

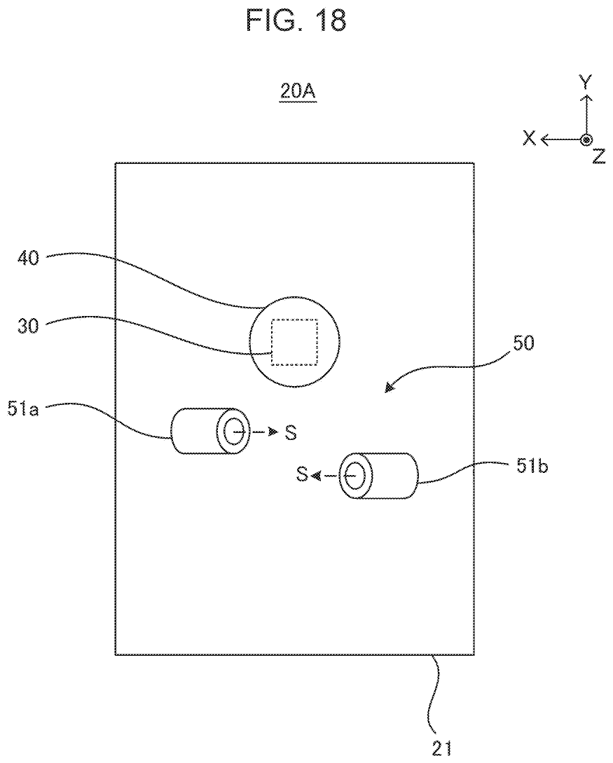

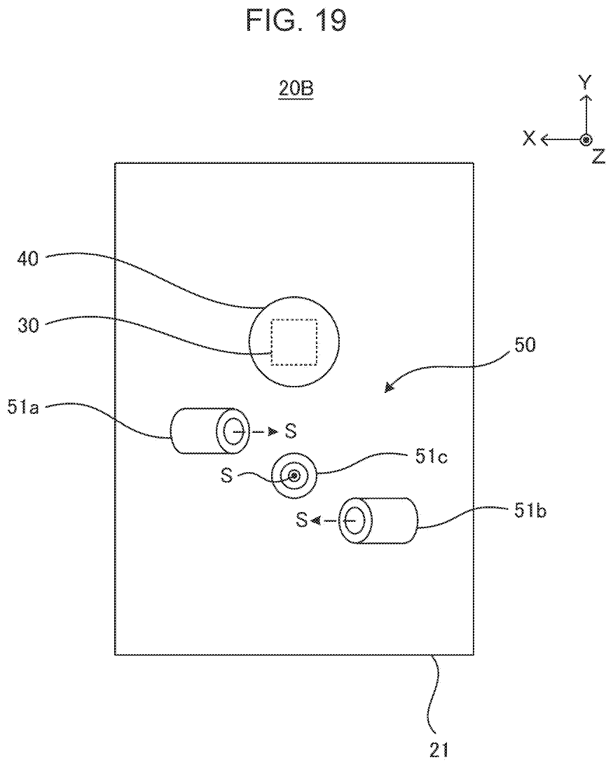

An optical distance-measuring device 20A according to a first example will first be described. FIG. 18 is a schematic front view of the optical distance-measuring device 20A according to the first example. For easy recognition of the arrangement of the plurality of PDs 51, FIG. 18 illustrates only the VCSEL array 30, the optical system 40, the plurality of PDs 51 included in the detecting unit 50, and the substrate 21 and does not illustrate the other elements. This also applies to FIGS. 19 to 26 illustrating configurations according to second to ninth examples.

As illustrated in FIG. 18, the optical distance-measuring device 20A according to the first example includes two PDs: a PD 51a and a PD 51b. The PD 51a and the PD 51b are located on the opposite sides relative to the center position C of the VCSEL array 30 in the X-axis direction. The detecting directions S of the PD 51a and the PD 51b are inclined toward the VCSEL array 30 in the X-axis direction. The PD 51a and the PD 51b are located at different positions in the Y-axis direction.

Now, an optical distance-measuring device 20B according to a second example will be described. FIG. 19 is a schematic front view of the optical distance-measuring device 20B according to the second example.

As illustrated in FIG. 19, the optical distance-measuring device 20B according to the second example is obtained by adding a PD 51c to the optical distance-measuring device 20A according to the first example at a position between the PD 51a and the PD 51b in the X-axis direction and such that the detecting direction S of the PD 51c is parallel to the optical axis A of the optical system 40.

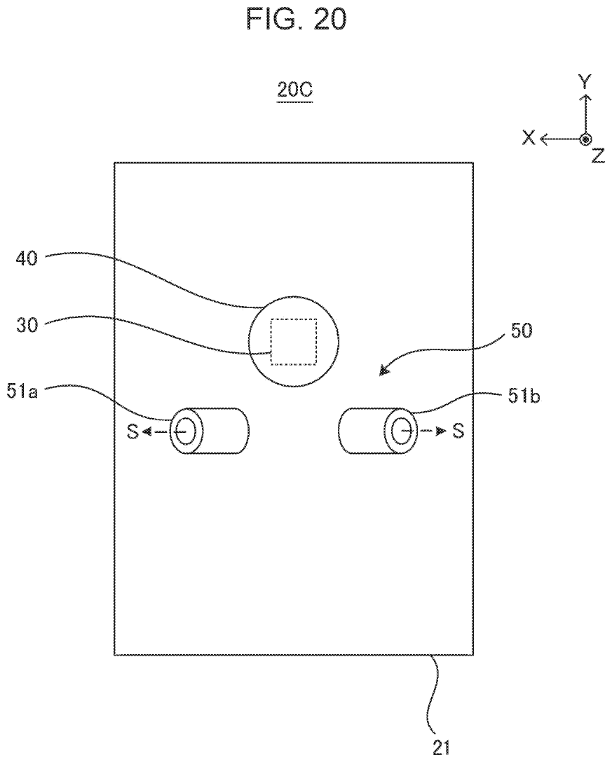

Now, an optical distance-measuring device 20C according to a third example will be described. FIG. 20 is a schematic front view of the optical distance-measuring device 20C according to the third example.

As illustrated in FIG. 20, the optical distance-measuring device 20C according to the third example includes two PDs: a PD 51a and a PD 51b. The PD 51a and the PD 51b are located on the opposite sides relative to the center position C of the VCSEL array 30 in the X-axis direction. The detecting directions S of the PD 51a and the PD 51b are inclined away from the VCSEL array 30 in the X-axis direction.

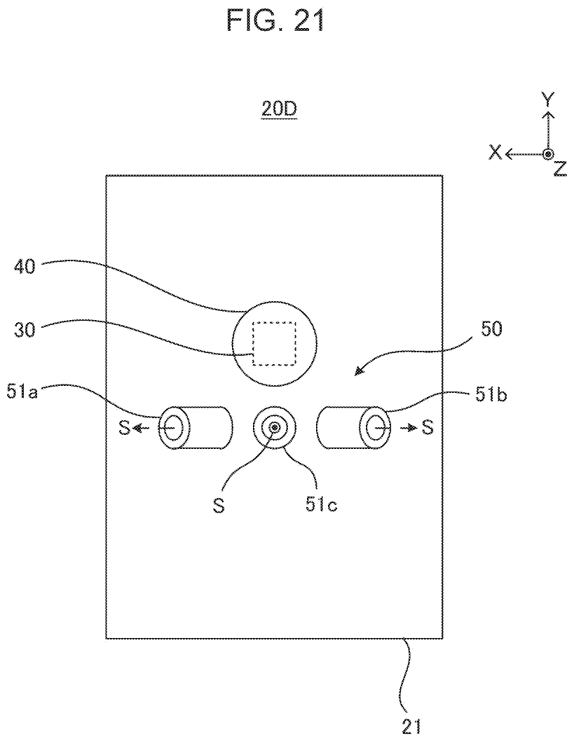

Now, an optical distance-measuring device 20D according to a fourth example will be described. FIG. 21 is a schematic front view of the optical distance-measuring device 20D according to the fourth example.

As illustrated in FIG. 21, the optical distance-measuring device 20D according to the fourth example is obtained by adding a PD 51c to the optical distance-measuring device 20C according to the third example at a position between the PD 51a and the PD 51b in the X-axis direction and such that the detecting direction S of the PD 51c is parallel to the optical axis A of the optical system 40.

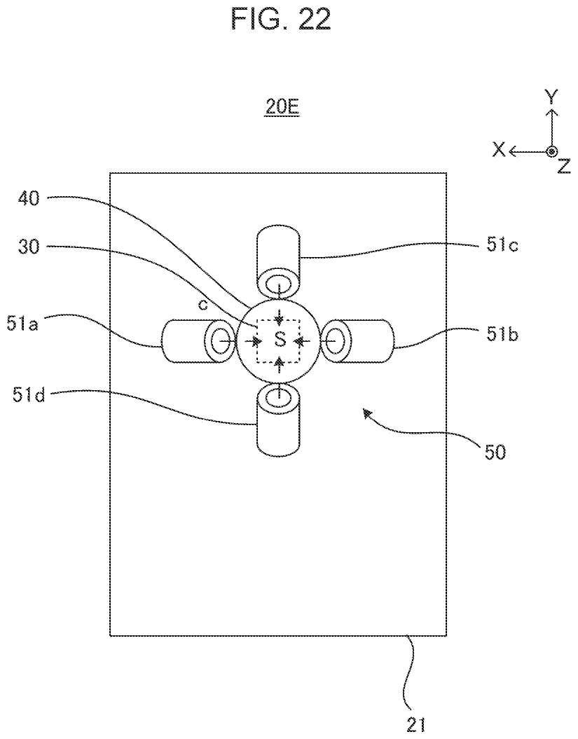

Now, an optical distance-measuring device 20E according to a fifth example will be described. FIG. 22 is a schematic front view of the optical distance-measuring device 20E according to the fifth example.

As illustrated in FIG. 22, the optical distance-measuring device 20E according to the fifth example includes four PDs 51a to 51d. The PD 51a and the PD 51b are located on the opposite sides relative to the center position C of the VCSEL array 30 in the X-axis direction. The detecting directions S of the PD 51a and the PD 51b are inclined toward the VCSEL array 30 in the X-axis direction.

The PD 51c and the PD 51d are located on the opposite sides relative to the center position C of the VCSEL array 30 in the Y-axis direction. The detecting directions S of the PD 51c and the PD 51d are inclined toward the VCSEL array 30 in the Y-axis direction.

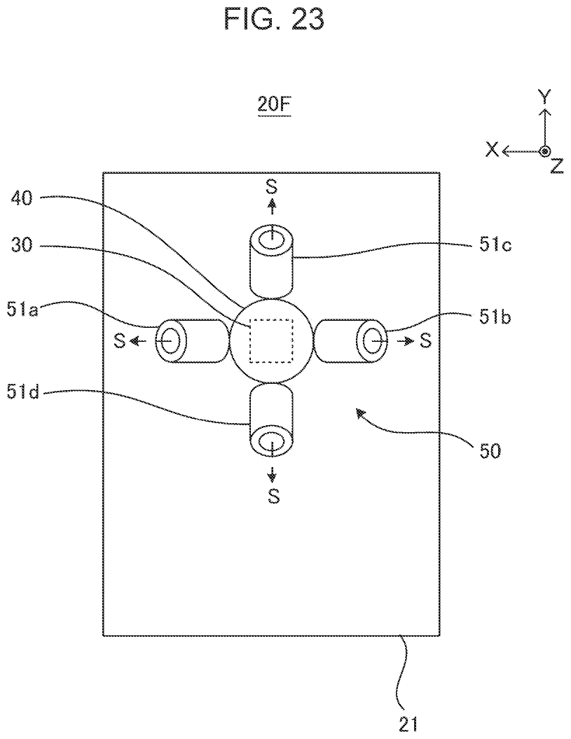

The optical distance-measuring device 20E according to the fifth example is obtained by adding the PD 51c and the PD 51d to the optical distance-measuring device according to the first example such that the detecting directions S of the PD 51c and the PD 51d are inclined toward opposite sides in the Y-axis direction, which is different from the X-axis direction in which the detecting directions S of the PD 51a and the PD 51b are inclined. Now, an optical distance-measuring device 20F according to a sixth example will be described. FIG. 23 is a schematic front view of the optical distance-measuring device 20F according to the sixth example.

As illustrated in FIG. 23, the optical distance-measuring device 20F according to the sixth example includes four PDs 51a to 51d. The PD 51a and the PD 51b are located on the opposite sides relative to the center position C of the VCSEL array 30 in the X-axis direction. The detecting directions S of the PD 51a and the PD 51b are inclined away from the VCSEL array 30 in the X-axis direction.

The PD 51c and the PD 51d are located on the opposite sides relative to the center position C of the VCSEL array 30 in the Y-axis direction. The detecting directions S of the PD 51c and the PD 51d are inclined away from the VCSEL array 30 in the Y-axis direction.

The optical distance-measuring device 20F according to the sixth example is obtained by adding the PD 51c and the PD 51d to the optical distance-measuring device according to the third example such that the detecting directions S of the PD 51c and the PD 51d are inclined toward opposite sides in the Y-axis direction, which is different from the X-axis direction in which the detecting directions S of the PD 51a and the PD 51b are inclined.

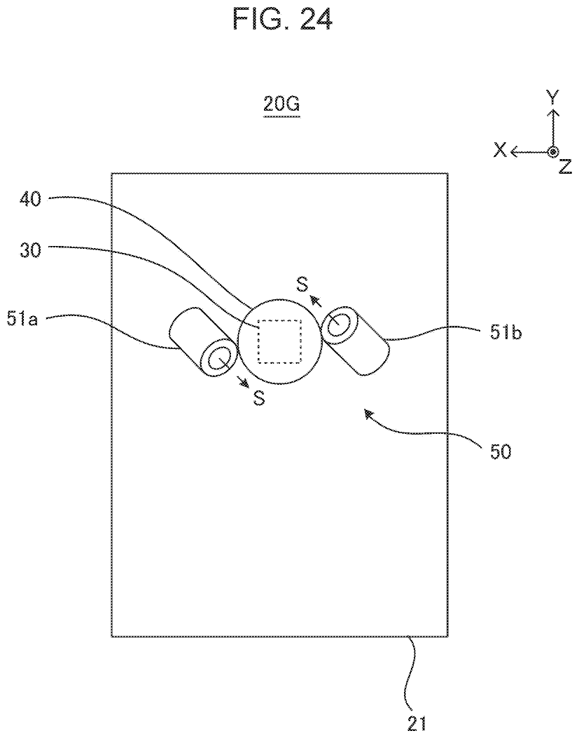

Now, an optical distance-measuring device 20G according to a seventh example will be described. FIG. 24 is a schematic front view of the optical distance-measuring device 20G according to the seventh example.

As illustrated in FIG. 24, the optical distance-measuring device 20G according to the seventh example includes two PDs 51a and 51b. The PD 51a and the PD 51b are located on the opposite sides relative to the center position C of the VCSEL array 30 in the X-axis direction. The detecting directions S of the PD 51a and the PD 51b are inclined toward the VCSEL array 30 in the X-axis direction and in the Y-axis direction.

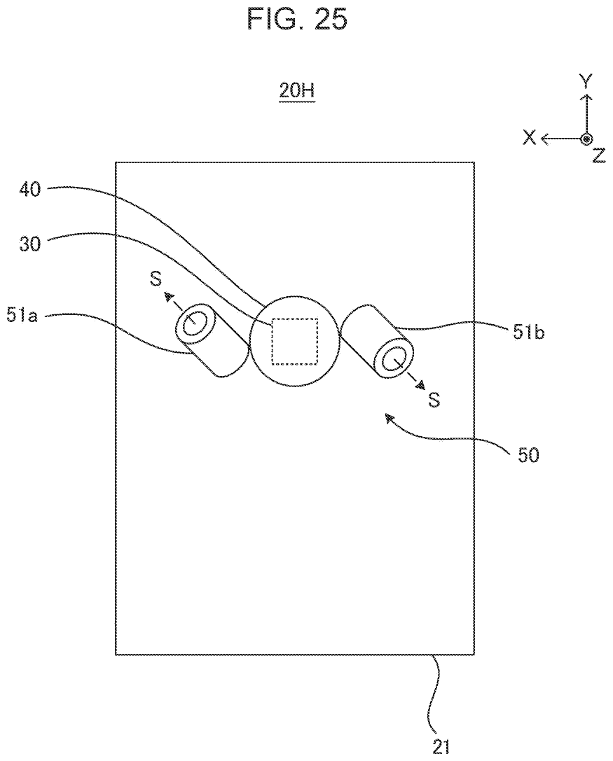

Now, an optical distance-measuring device 20H according to an eighth example will be described. FIG. 25 is a schematic front view of the optical distance-measuring device 20H according to the eighth example.

As illustrated in FIG. 25, the optical distance-measuring device 20H according to the eighth example includes two PDs 51a and 51b. The PD 51a and the PD 51b are located on the opposite sides relative to the center position C of the VCSEL array 30 in the X-axis direction. The detecting directions S of the PD 51a and the PD 51b are inclined away from the VCSEL array 30 in the X-axis direction and toward the VCSEL array 30 in the Y-axis direction.

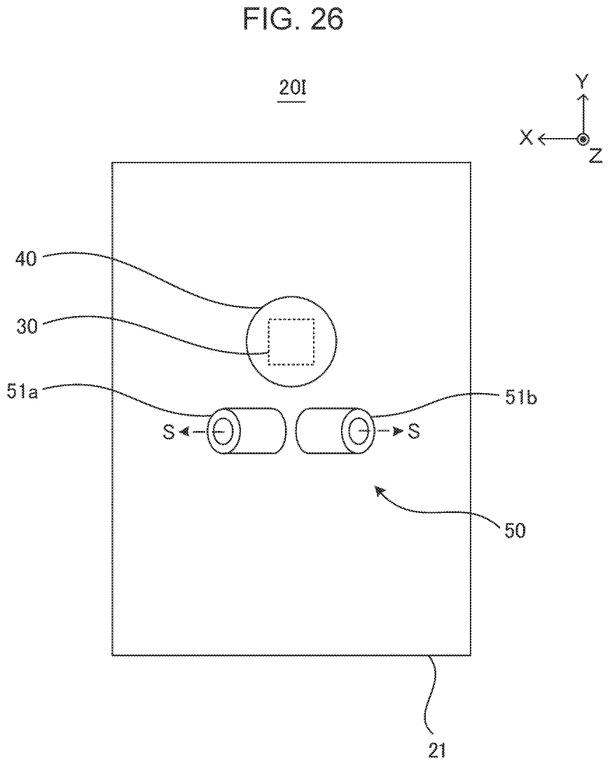

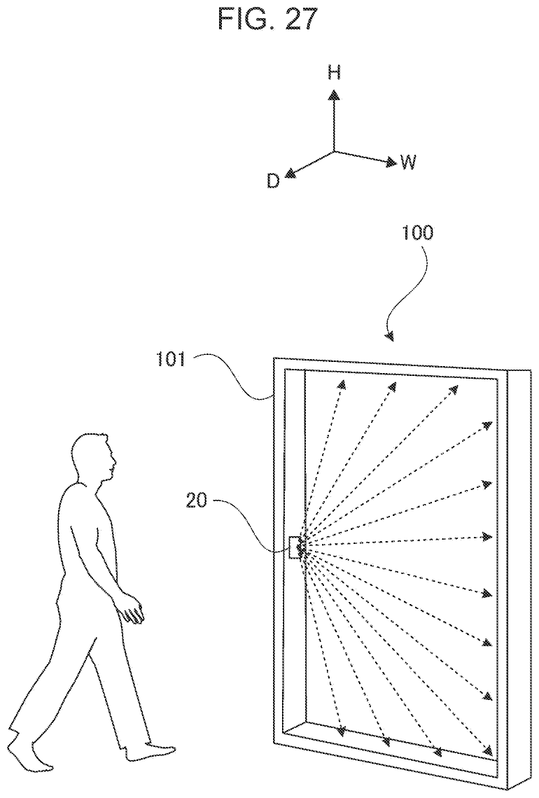

Now, an optical distance-measuring device 20I according to a ninth example will be described. FIG. 26 is a schematic front view of the optical distance-measuring device 20I according to the ninth example.

As illustrated in FIG. 26, the optical distance-measuring device 20I according to the ninth example is obtained by changing the optical distance-measuring device according to the first example such that the interval between the two PDs 51a and 51b in the X-axis direction is shortened.

### Second Exemplary Embodiment

FIG. 27 is a schematic external view of a human-sensing gate 100 according to a second exemplary embodiment of the present disclosure. The W axis, the H axis, and the D axis provided in FIG. 27 represent the coordinate axes of the human-sensing gate 100. The W axis extends in a horizontal direction and represents the width direction of the human-sensing gate 100, the H axis extends in the vertical direction and represents the top-to-bottom direction of the human-sensing gate 100, and the D axis extends in another horizontal direction and represents the depth direction of the human-sensing gate 100.

As illustrated in FIG. 27, the human-sensing gate 100 is configured to detect the passage of any person through a frame 101. The frame 101 is provided on an inner side face thereof with the optical distance-measuring device 20, which serves as a human sensor configured to detect any person passing through the frame 101.

The human-sensing gate 100 according to the second exemplary embodiment uses the optical distance-measuring device 20 to detect, for example, any person going into or out of a facility or premises provided with the human-sensing gate 100 by detecting any person passing through the frame 101.

The configuration of the optical distance-measuring device 20 is the same as in the first exemplary embodiment and is not described here.

The optical distance-measuring device 20 is set on the frame 101 of the human-sensing gate 100 such that the X-axis direction thereof coincides with the vertical direction of the human-sensing gate 100 while the Y-axis direction thereof coincides with the horizontal direction of the human-sensing gate 100.

### Modifications

While the above exemplary embodiments each relate to a case where the present disclosure is applied to the image forming apparatus 10 or the human-sensing gate 100, the present disclosure is not limited to such a usage and is also applicable to the following: an information processing apparatus, such as an automatic teller machine (ATM) or a ticket vending machine, configured to be operated by a user who has approached the apparatus; and to an apparatus, such as a self-propelled unattended transporting vehicle or a cleaning robot, configured to detect any obstacles.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

The following are preferable embodiments of the present disclosure.

(((1)))

An optical distance-measuring device comprising:
a light emitter having a plurality of light-emitting areas that are arrayed in a first direction;
an optical system provided at a position toward which the light emitter emits light, the optical system causing light beams respectively emitted from the plurality of light-emitting areas to be deflected in respectively different directions; and
a detector including a plurality of detecting elements configured to detect a reflection of light outgoing from the optical system,
wherein detecting directions of some of the plurality of detecting elements are different from detecting directions of others of the plurality of detecting elements in the first direction.
   (((2)))

The optical distance-measuring device according to (((1))),
wherein the detecting elements of the detector include detecting elements located on opposite sides relative to a center position of the light emitter in the first direction.
   (((3)))

The optical distance-measuring device according to (((2))),
wherein the detecting directions of the detecting elements located on the opposite sides relative to the center position of the light emitter in the first direction are inclined toward the light emitter in the first direction.
   (((4)))

The optical distance-measuring device according to (((3))),
wherein the detecting elements located on the opposite sides relative to the center position of the light emitter in the first direction are located at different positions in a second direction that intersects the first direction.
   (((5)))

The optical distance-measuring device according to (((2))),
wherein the detecting directions of the detecting elements located on the opposite sides relative to the center position of the light emitter in the first direction are inclined away from the light emitter in the first direction.
   (((6)))

The optical distance-measuring device according to any of (((2))) to (((5))),
wherein a direction of drawing a wire from each of the detecting elements located on the opposite sides relative to the center position of the light emitter in the first direction is inclined toward the light emitter in the first direction.
   (((7)))

The optical distance-measuring device according to any of (((1))) to (((6))),
wherein the detecting elements of the detector include detecting elements located on opposite sides relative to a center position of the light emitter in a second direction that intersects the first direction.
   (((8)))

The optical distance-measuring device according to any of (((1))) to (((7))),
wherein the detecting elements of the detector include two detecting elements that are inclined toward opposite sides in the first direction and whose inclinations with respect to an optical axis of the optical system are each 42.5° or greater and 62.5° or smaller in absolute value.
   (((9)))

An image forming apparatus comprising:
the optical distance-measuring device according to any of (((1))) to (((8))),
wherein the light emitter is set such that the first direction coincides with a horizontal direction while a second direction intersecting the first direction coincides with a vertical direction.

What is claimed is:

1. An optical distance-measuring device comprising:
a light emitter having a plurality of light-emitting areas that are arrayed in a first direction;
an optical system provided at a position toward which the light emitter emits light, the optical system causing light beams respectively emitted from the plurality of light-emitting areas to be deflected in respectively different directions; and
a detector including a plurality of detecting elements configured to detect a reflection of light outgoing from the optical system,
wherein detecting directions of some of the plurality of detecting elements are different from detecting directions of others of the plurality of detecting elements in the first direction.

2. The optical distance-measuring device according to claim 1,
wherein the detecting elements of the detector include detecting elements located on opposite sides relative to a center position of the light emitter in the first direction.

3. The optical distance-measuring device according to claim 2,
wherein the detecting directions of the detecting elements located on the opposite sides relative to the center position of the light emitter in the first direction are inclined toward the light emitter in the first direction.

4. The optical distance-measuring device according to claim 3,
wherein the detecting elements located on the opposite sides relative to the center position of the light emitter in the first direction are located at different positions in a second direction that intersects the first direction.

5. The optical distance-measuring device according to claim 2,
wherein the detecting directions of the detecting elements located on the opposite sides relative to the center position of the light emitter in the first direction are inclined away from the light emitter in the first direction.

6. The optical distance-measuring device according to claim 2,
wherein a direction of drawing a wire from each of the detecting elements located on the opposite sides relative to the center position of the light emitter in the first direction is inclined toward the light emitter in the first direction.

7. The optical distance-measuring device according to claim 1,
wherein the detecting elements of the detector include detecting elements located on opposite sides relative to a center position of the light emitter in a second direction that intersects the first direction.

8. The optical distance-measuring device according to claim 1,
wherein the detecting elements of the detector include two detecting elements that are inclined toward opposite sides in the first direction and whose inclinations with respect to an optical axis of the optical system are each 42.5° or greater and 62.5° or smaller in absolute value.

9. An image forming apparatus comprising:
the optical distance-measuring device according to claim 1,
wherein the light emitter is set such that the first direction coincides with a horizontal direction while a second direction intersecting the first direction coincides with a vertical direction.

10. An image forming apparatus comprising:
the optical distance-measuring device according to claim 2,
wherein the light emitter is set such that the first direction coincides with a horizontal direction while a second direction intersecting the first direction coincides with a vertical direction.

11. An image forming apparatus comprising:
the optical distance-measuring device according to claim 3,
wherein the light emitter is set such that the first direction coincides with a horizontal direction while a second direction intersecting the first direction coincides with a vertical direction.

12. An image forming apparatus comprising:
the optical distance-measuring device according to claim 4,
wherein the light emitter is set such that the first direction coincides with a horizontal direction while a second direction intersecting the first direction coincides with a vertical direction.

13. An image forming apparatus comprising:
the optical distance-measuring device according to claim 5,
wherein the light emitter is set such that the first direction coincides with a horizontal direction while a second direction intersecting the first direction coincides with a vertical direction.

14. An image forming apparatus comprising:
the optical distance-measuring device according to claim 6,
wherein the light emitter is set such that the first direction coincides with a horizontal direction while a second direction intersecting the first direction coincides with a vertical direction.

15. An image forming apparatus comprising:
the optical distance-measuring device according to claim 7,
wherein the light emitter is set such that the first direction coincides with a horizontal direction while a second direction intersecting the first direction coincides with a vertical direction.

16. An image forming apparatus comprising:
the optical distance-measuring device according to claim 8,
wherein the light emitter is set such that the first direction coincides with a horizontal direction while a second direction intersecting the first direction coincides with a vertical direction.

17. An optical distance-measuring device comprising:
means for emitting light, the means having a plurality of light-emitting areas that are arrayed in a first direction;
means for deflecting light, the means provided at a position toward which the means for emitting light emits light, the means for deflecting light causing light beams respectively emitted from the plurality of light-emitting areas to be deflected in respectively different directions; and
means for detecting light, the means including a plurality of detecting elements configured to detect a reflection of light outgoing from the means for deflecting light,
wherein detecting directions of some of the plurality of detecting elements are different from detecting directions of others of the plurality of detecting elements in the first direction.
